(19) United States
(12) Patent Application Publication
(10) Pub. No.: US 2007/0058980 A1
(43) Pub. Date: Mar. 15, 2007

(54) Optical transceiver suppressing radiation noise form transmitter to receiver

(76) Inventor: Hirotoshi Hidaka, Kanagawa (JP)

Correspondence Address: Dennis C. Rodgers;Smith, Gambrell & Russell, Suite 800, 1850 M Street, Washington, DC, 20036, US

(21) Appl. No.: 11/496,007

(22) Filed: Jul. 31, 2006

(30) Foreign Application Priority Data
Aug. 3, 2005 (JP) P2005-225651

(51) Int. Cl. H04B 10/00

(52) U.S. Cl. 398/138

(57) ABSTRACT

An influence of noise propagated from a transmitting circuit to a receiving circuit is reduced in an optical transceiver. The optical transceiver includes a transmitter optical subassembly (TOSA), a receiver optical subassembly (ROSA) including a light receiving element, a transmitting circuit for driving a light emitting element in TOSA, a receiving circuit for processing an electric signal from ROSA, and a printed circuit board mounted with the transmitting circuit and the receiving circuit. TOSA and ROSA are connected to the printed circuit board respectively by a first and a second flexible board. The printed circuit board includes a face mounted with the transmitting circuit. The second flexible board is provided with a ground layer at one face thereof and is provided with a signal line at a face on an opposed side. The second flexible board is arranged by directing the ground layer to a side of a face mounted with the transmitting circuit.

### BACKGROUND OF THE INVENTION

1. TECHNICAL FIELD

The present invention relates to an optical transceiver for transmitting and receiving an optical signal.

2. RELATED ART

In optical communication, an optical transceiver for dealing with an electric signal and an optical signal is frequently used. Generally, according to an optical transceiver, a transmitter optical subassembly (hereinafter, ‘TOSA’) for receiving an electric signal to convert into an optical signal, and a receiver optical subassembly (hereinafter, ‘ROSA’) for receiving an optical signal to convert into an electric signal are connected to a printed circuit board (hereinafter ‘PCB’) for processing an electric signal. The circuit board is mounted with a transmitting circuit for generating a drive signal to be supplied to TOSA, and a receiving circuit for receiving an electric signal from ROSA to process.

In recent years, with an increase in an information amount of transmitting data, an optical transceiver needs to transmit a high speed signal of about 10 Gbps. On the other hand, also a request for downsizing a transmitting apparatus is strong, and also downsizing an optical transceiver has been promoted in accordance therewith. Normally, an optical transceiver contains a PCB for mounting a transmitting circuit and a receiving circuit, a transmitter optical subassembly (hereinafter, ‘TOSA’) including a light emitting element (or a light emitting element and a peripheral circuit thereof), and a receiver optical subassembly (hereinafter, ‘ROSA’) including a light receiving element (or a light receiving element and a peripheral circuit of an amplifier or the like). An optical transceiver conceived here is provided with a small package size of, for example, 18.4 mm×78.0 mm×8.5 mm and deals with transmission of a high speed signal having a transmission rate of 10 Gbps.

When a signal is transmitted at a speed as high as 10 Gbps, a characteristic impedance of a transmission path needs to be matched to, for example, 50Ω. However, according to a method of directly connecting a lead pin of a subassembly (TOSA or ROSA) to a PCB, it is difficult to match an impedance at a portion of the lead pin to the characteristic impedance. Hence, a method of connecting a subassembly to a PCB by way of a flexible board is generally adopted. The flexible board is formed with a transmission path and by constituting the transmission path by a microstrip line, a characteristic impedance thereof can be matched to 50Ω.

The flexible board includes a conductor in a strip-like shape as the transmission path at one face thereof and widely formed with a ground layer at other face thereof by interposing an insulating layer therebetween and by the mode, the characteristic impedance can be matched to 50Ω. Polyimide is frequently used generally for the insulating layer. The characteristic impedance can be adjusted by changing a thickness of the insulating layer and a thickness and a width of the conductor in the strip-like shape, for which a copper foil is generally used. In comparison with connection by the lead pin, a large ground layer can be formed at the one face of the flexible board and therefore, also an advantage of stabilizing a ground potential is achieved.

When TOSA and ROSA are contained in a small-sized package, suppression of an adverse influence effected by noise generated at inside of the optical transceiver on a receiving signal (that is, ROSA output) poses a serious problem. The adverse influence will be explained in reference to FIG. 1. Here, FIG. 1 is an outline view showing an example of crosstalk generated between a transmitting circuit and a receiving circuit of an optical transceiver.

TOSA 10 is connected to a PCB 40 by way of a flexible board 12, and ROSA 20 is connected to the PCB 40 by way of a flexible board 22, respectively. A transmitting circuit 41 and a receiving circuit 46 are mounted on one face, that is, an upper face of the PCB 40. The transmitting circuit 41 is mounted with a driver 42 and an amplifier IC 43. The driver 42 supplies a drive signal having a large amplitude to TOSA 10 for driving a laser diode at inside of TOSA 10. For example, a signal having an amplitude of about 0.5 Vp-p is supplied to TOSA 10 with regard to a laser diode and a signal having an amplitude of about 2.0 through 4.0 Vp-p is supplied to TOSA 10 with regard to a laser having an external modulator. The transmitting circuit 41 includes a wiring 45 for connecting a driver 42 to a signal line 94a on the flexible board 92.

On the other hand, ROSA 20 outputs only a weak electric signal of about several tens mVp-p when ROSA 20 receives an optical signal having a weak intensity. The receiving circuit 46 includes a clock/data recovering circuit (CDR-IC) 47 including a main amplifier for amplifying such an electric signal, and a wiring 48 for connecting CDR-IC 47 to a high frequency signal line 24a on the flexible board 22. At inside of the optical transceiver, as shown by an arrow mark of FIG. 4, unnecessary radiation of a large amplitude signal from the transmitting circuit 41, that is, noise interferes with a weak signal on the high frequency signal line 24a on a side of ROSA to deteriorate a receiving sensitivity.

JP-A-2003-249711 discloses a technology for carrying out impedance matching by connecting TOSA, ROSA and PCB by a flexible board including a transmission path a characteristic impedance of which is matched to 50Ω. JP-A-11-345987 discloses a technology of connecting TOSA and ROSA to two sheets of PCBs aligned in parallel respectively by way of flexible boards. JP-A-2001-85733 discloses a constitution enveloping a receiving circuit and a transmitting circuit by folding back a PCB constituted by a ground layer to minimize an influence of crosstalk between the transmitting and receiving circuits by spatial propagation. U.S. Pat. Publication No. 2003/0214860 uses a flexible board for connecting TOSA, ROSA to a PCB. Although in a background art, a width of a high speed signal line is controlled in order to match a characteristic impedance to high speed signals of both of a flexible board and a printed board, a discontinuity of impedance is brought about at a point of connecting the two boards to bring about reflection. Hence, according to the technology, the impedance matching is carried out by making the line width constant and controlling a distance between the signal line and the ground layer.

It is a problem of the invention to provide an optical transceiver for reducing crosstalk noise spatially propagated from a transmitting circuit to a receiving circuit.

### SUMMARY OF THE INVENTION

An optical transceiver according to the invention includes a transmitter optical subassembly, a receiver optical subassembly, a transmitting circuit, a receiving circuit, a printed circuit board, a first flexible board, a second flexible board. The printed circuit board is mounted with the transmitting circuit and the receiving circuit. The first flexible board connects the transmitting circuit and the transmitter optical subassembly. The second flexible board connects the receiving circuit and the receiver optical subassembly. The second flexible board includes a first face formed with a transmission line for connecting the receiving circuit and the receiver optical subassembly, and a second face which is a face opposed to the first face and includes a first ground layer connected to a ground layer on the printed circuit board. Further, the invention is characterized in that the second face of the second flexible board is arranged to be directed to a face of the printed circuit board mounted with the transmitting circuit.

The transmission line formed at the first face of the second flexible board is shielded from the transmitting circuit on the printed circuit board by the ground layer formed at the second face and therefore, the transmission line of propagating the weakest signal at inside of the optical transceiver is isolated from noise generated by the transmitting circuit. Further, the transmission line is matched to a predetermined transmission impedance between the transmission line and the ground layer formed at the second face.

It is preferable to mount the transmitting circuit and the receiving circuit respectively at separated faces of the printed circuit board. Even when mounted on the same face, it is preferable to cover the receiving circuit by a shield member. The shield member can be constituted by a third flexible board having a ground layer at one face thereof. One end of the third flexible board includes an electrode constituted by extending the ground layer and by connecting the electrode to the ground layer on the printed circuit board, the receiving circuit on the printed circuit board is shielded. It is preferable that the third flexible board is formed in an arch-like shape by constituting a fixed point by the electrode and the face formed with the ground layer is made to constitute an inner face of the arch-like shape.

### BRIEF DESCRIPTION OF THE DRAWINGS

FIG. 1 is an outline view showing an example of crosstalk between transmitting and receiving circuits;

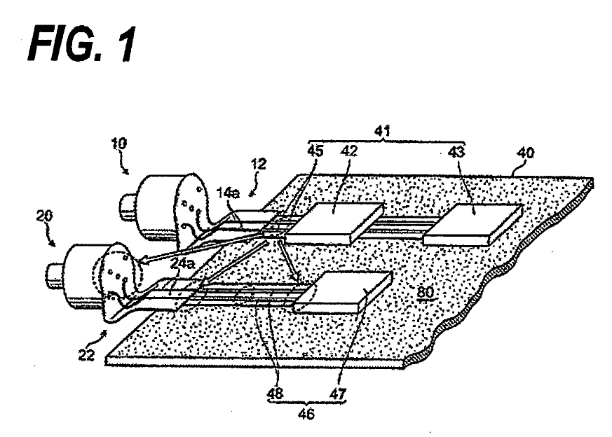

FIG. 2 is an outline perspective view showing an optical transceiver according to a first embodiment;

FIG. 3 is an outline side view showing the optical transceiver according to the first embodiment;

FIG. 4 is an outline side view showing an optical transceiver according to a second embodiment;

FIG. 5 is an outline plane view showing a structure of an optical transceiver according to a third embodiment;

FIG. 6 is an outline back view showing a structure of an optical transceiver according to a fourth embodiment; and

FIG. 7 is an outline plane view showing a flexible board before being bent.

### DESCRIPTION OF THE PREFERABLE EMBODIMENTS

The embodiments of the invention will be described in details in reference to the attached drawings as follows. Further, in explaining the drawings, the same elements are attached with the same notations and a duplicated explanation thereof will be omitted.

### First Embodiment

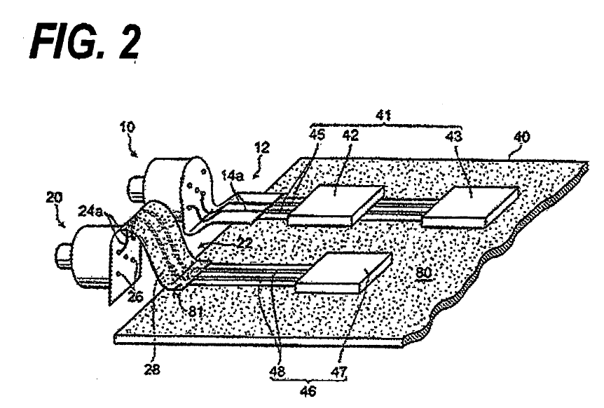

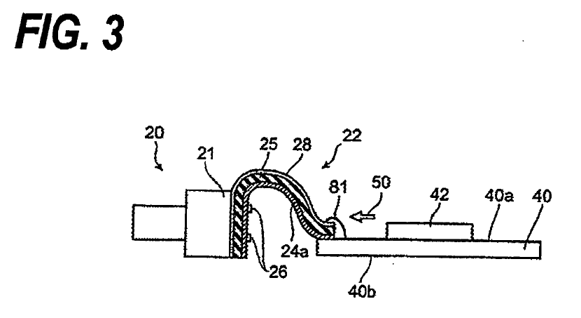

FIG. 2 is an outline perspective view showing a structure of an optical transceiver according to a first embodiment, FIG. 3 is an outline side view showing an arrangement of the flexible board 22 according to the embodiment. Further, in FIG. 3, CDR-IC 43, the receiving circuit 46 and TOSA 10 are omitted in order to show a positional relationship among ROSA 20, the flexible board 22 and the driver IC 42.

As shown by FIG. 3, the PCB 40 includes two faces opposed to each other. In the following, the faces are referred to as an upper face 40a and a lower face 40b. The transmitting circuit 41 and the receiving circuit 46 are provided at the upper face 40a of the PCB 40. The flexible board 22 is provided with a structure of a microstrip line in which an insulating layer 25 is interposed by a high frequency signal line 24a and a ground layer 28. One end portion of the flexible board 22 is attached to a stem 21 of ROSA 20, and a lead pin 26 projected from the stem 21 penetrates an end portion thereof. Other end portion of the flexible board 22 is connected to the upper face 40a of the PCB 40.

As shown by FIG. 2 and FIG. 3, the flexible board 22 is arranged such that the ground layer 28 is directed to a side of the upper face 40a of the PCB 40. That is, the ground layer 28 appears at the upper face of the flexible board 22 and the high frequency signal line 24a is concealed at the lower face. The flexible board 22 is bent such that the ground layer 28 is projected to be higher than the PCB 40 and the stem 21. The high frequency signal line 24a is connected to the signal line 48 on the PCB 40 by soldering or the like.

A ground layer 80 is provided at the upper face 40a of the PCB 40. One end of the ground layer 28 is connected to the ground layer 80 by way of a conductor 81. The ground layer 28 connects the stem 21 of ROSA 20 to the ground layer 80 of the PCB 40 other than a role thereof as a shield, mentioned later.

According to the embodiment, the ground layer 28 is directed to the side of the upper face 40a of the PCB 40 provided with the transmitting circuit 41 (particularly, the driver IC 42) constituting a source of noise and therefore, the ground layer 28 is interposed between the lead pin 26 and the high frequency signal line 24a and the transmitting circuit 41. The shield comprising the ground layer 28 shields noise 50 radiated from the transmitting circuit 41. As a result, crosstalk on the transmitting circuit 41 to the lead pin 26 or the signal line 24a is reduced.

### Second Embodiment

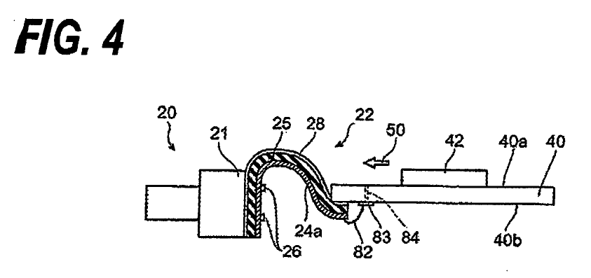

An optical transceiver according to a second embodiment of the invention is provided with a structure the same as that of the first embodiment except arrangement of the flexible board 22. FIG. 4 is an outline side view showing a flexile board 22 in the second embodiment.

Similar to the first embodiment, the flexible board 22 is arranged such that the ground layer 28 is directed to the side of the upper face 40a of the PCB 40. However, different from the first embodiment, the end portion of the flexible board 22 is connected to the lower face 40b of the PCB 40. The PCB 40 includes a via hole 84 extended between an electrode pad 83 provided at the lower face 40b and the signal line 48 provided at the upper face 40a. The electrode pad 83 is connected to the high frequency signal line 24a by way of a conductor 82. As a result, an end portion of the high frequency signal line 24a provided on the side of the lower face 40b is electrically connected to the signal line 48 provided at the upper face 40a by way of the conductor 82, the electrode pad 83, and the via hole 84.

Similar to the first embodiment, the shield comprising the ground layer 28 is formed between the stem 21 of ROSA 20 and the transmitting circuit 41 (particularly, the driver IC 42). The shield shields the noise 50 generated from the transmitting circuit 41 and therefore, crosstalk from the transmitting circuit 41 to the lead pin 26 and the signal line 24a can be reduced and interference with the output signal of ROSA 20 by the noise 50 can be suppressed.

When the flexible board 22 is arranged by directing the signal line 24a to the side of the upper face 40a of the PCB 40, a front end of the lead pin 26 penetrated through the flexible board 22 and the signal line 24a of the flexible board 22 are directly exposed to the noise 50 from the transmitting circuit 41 (particularly, the driver IC 42). Therefore, the noise 50 jumps into the lead pin 26 or the high frequency signal line 24a and a receiving characteristic is liable to be deteriorated. In contrast thereto, according to the first and the second embodiments, the stem 21 and the high frequency signal line 24a are covered by the ground layer 28 of the flexible board 22 and therefore, the receiving characteristic can be prevented from being deteriorated.

According to the embodiments, two portions which are easy to undergo the noise the most, that is, lead pin 26 of ROSA 20 and the signal line 24a on the flexible board 22 connected to ROSA 20 are shielded by the ground layer 28. However, there is a possibility that also the receiving circuit 46 on the PCB 40, that is, CDR-IC 47 and the wiring 48 undergo the noise. In the following, an explanation will be given of a mode of protecting the receiving circuit 46 from the noise.

The PCB 40 is generally a multilayered board and formed with a wide ground layer at an inner layer thereof. Hence, when CDR-IC 47 is mounted on a side opposed to the transmitting circuit 41, CDR-IC 47 is prevented from being effected with the influence of noise from the transmitting circuit 41. Further, it is preferable to provide the wiring 48 at a face opposed to the face formed with the transmitting circuit 41 or at an inner layer of the PCB 40. When the first embodiment is modified in this way, since the signal line 24a is connected to the upper face of the PCB 40, the high frequency signal line 24a is conducted to CDR-IC 47 on the lower face 40b by providing a via hole at the PCB 40.

Even when CDR-IC 47 is obliged to be mounted to the face the same as the face of mounting the transmitting circuit 41, it is preferable to make the wiring 48 reaching CDR-IC 47 from ROSA 20 run at the inner face of the PCB 40. However, there can also be a case in which the wiring 48 is obliged to be provided at the upper face 40a of the PCB 40 similar to the transmitting circuit 41.

It is necessary to conceive other method when (a) there is not an allowance in an area of the board, (b) it is necessary to make the wiring 48 run on the surface of the PCB 40 in order to provide a coupling capacitor or a frequency characteristic correcting circuit, and (c) it is difficult to adopt a part arrangement which is difficult to be effected with the influence of the noise. The following relates to an optical transceiver suitable for being used under such a restriction.

### Third Embodiment

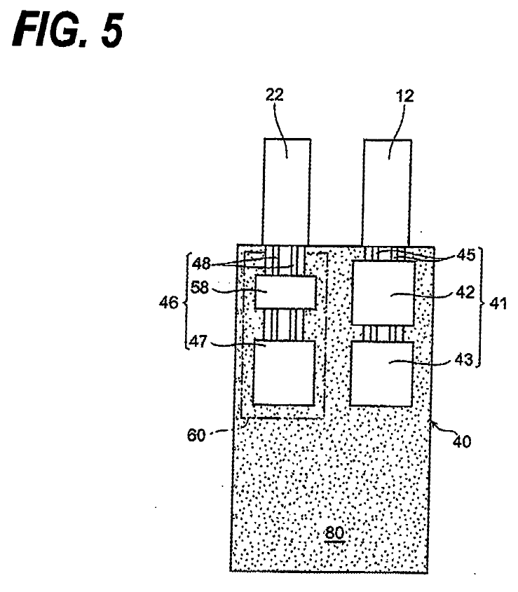

FIG. 5 is an outline plane view showing a structure of an optical transceiver according to a third embodiment of the invention. The optical transceiver of the embodiment is provided with a constitution of adding a correcting circuit 58 and a shield member 60 to the optical transceiver of the first embodiment. The correcting circuit 58 is provided at a middle of the wiring 48 for correcting a frequency characteristic of a signal transmitted on the wiring 48. In this way, according to the embodiment, the receiving circuit 46 is constituted by CDR-IC 47, the wiring 48 and the correcting circuit 58.

The shield member 60 is constituted by, for example, a box-like shape made of a metal, connected to the upper face 40a of the PCB 40 by solder and covers CDR-IC 47, the wiring 48, and the correcting circuit 58. The shield member 60 is connected to the ground layer 80. The shield member 60 reduces crosstalk by shielding the noise 50 radiated from the transmitting circuit 41.

### Fourth Embodiment

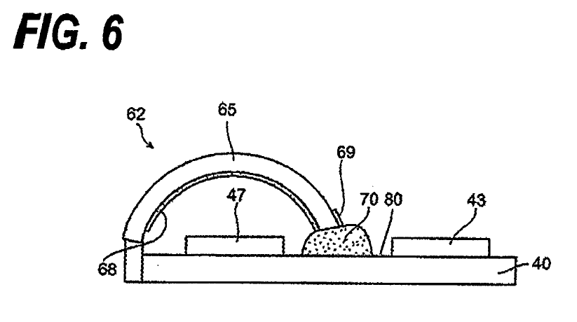

A fourth embodiment according to the invention will be explained as follows. The embodiment provides other method of shielding the receiving circuit 46. FIG. 6 is an outline back view showing a structure of an optical transceiver according to the embodiment. According to the embodiment, the receiving circuit 46 is shielded by using a flexible board 62.

As shown by FIG. 6, the flexible board 62 is provided with a structure of providing a ground layer 68 comprising a copper foil on one face of an insulating layer 65. an electrode 69 comprising a copper foil is provided on other face of the insulating layer 65. As mentioned later, the electrode is a portion of the ground layer 68. An end portion of the flexible board 62 including the electrode 69 is connected to the ground layer 80 of the PCB 40 by a solder 70. The ground layer 68 is arranged at a face on an inner side, that is, an inner surface of the flexible board 62, and the electrode 69 is arranged at a face on an outer side, that is, an outer surface of the flexible board 62.

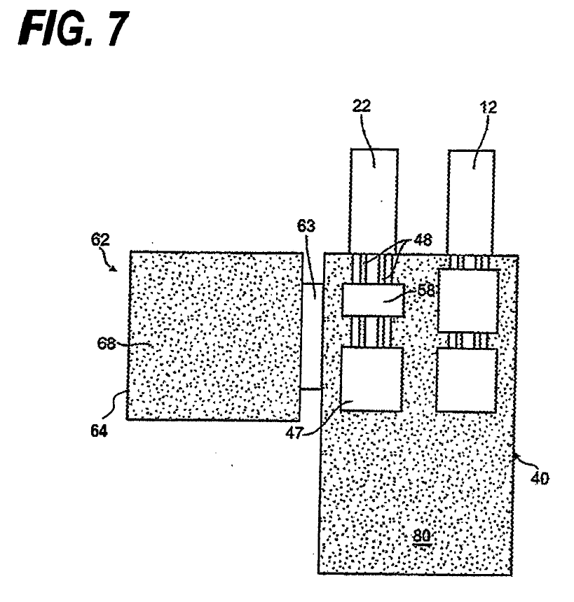

FIG. 7 is an outline plane view showing the flexible board 62 before being bent. An end portion 63 of the flexible board 62 on a side opposed to an end portion 64 to be soldered is connected to an edge of the PCB 40 at a side of CDR-IC 47, the signal line 48 and the correcting circuit 58. The flexible board 62 is bent to cover CDR-IC 47, the signal line 48 and the correcting circuit 58 by constituting a fulcrum by the end portion 63.

The ground layer 68 covers a large portion of one face of the flexible board 62 and made to be round about to the opposed face at the end portion 64. The round about portion is the electrode 69 mentioned above. The ground layer 68 is not provided at the end portion 63 of the flexible board 62 connected to the PCB 40.

The ground layer 68 and the ground layer 80 on the PCB 40 are connected at the end portion 64. By avoiding electric connection thereto the end portion 63 constituting the fulcrum when the flexible board 62 is bent, two requirements of downsizing the optical transceiver and avoidance of cutting ground connection can be satisfied.

Generally, when a flexible board is bent strongly, a wiring formed at a surface thereof or inside thereof is disconnected, or a protective film on a surface is broken and an inner wiring is exposed. Particularly, such strong bending is liable to be brought about at the portion of connecting the printed board and the flexible board. Hence, according to the embodiment, the electric connection is carried out at the end portion 64 (soldered portion) on a side of being remote from the end portion 63 to thereby avoid disconnection between the ground layers 68 and 80. Further, by considerably bending the flexible board 62 at the end portion 63, the PCB 40 can be made to be proximate to a cabinet 88 of the optical transceiver and therefore, the optical transceiver can also be downsized.

A detailed explanation has been given of the invention based on the embodiments as mentioned above. However, the invention is not limited to the above-described embodiments. The invention can be modified variously within the range not deviated from the gist.

According to the embodiment, the ground layer 28 of the flexible board 22, the shield member 60, and the ground layer 68 of the flexible board 62 are connected to a ground potential by way of the ground layer 80 of the PCB 40. However, these may be connected to other conductive layer having a constant potential in place of the ground layer 80. It is preferable that the conductive layers are provided with a sufficiently wide area to stabilize the potential. Further, although the ground layer 80 is provided at the upper face 40a of the PCB 40, the ground layer 80 may be provided to the lower face 40b.

What is claimed is:

1. An optical transceiver for transmitting and receiving optical signals, comprising:
a transmitter optical subassembly including a light-emitting device;
a receiver optical subassembly including a light-receiving device;
a transmitter circuit for supplying a transmitting electrical signal to the light-emitting device;
a receiver circuit for processing a receiving signal output from the light-receiving device;
a printed circuit board installing the transmitter circuit on one surface thereof and receiver circuit, the printer circuit board providing a ground layer;
a first flexible printed circuit with one end connected to the transmitter optical subassembly and the other end connected to the printed circuit board; and
a second flexible printed circuit with one end connected to the receiver optical subassembly and the other end connected to the printed circuit board, the second flexible printed circuit having a first surface and a second surface opposite to the first surface, the first surface forming a transmission line connecting the receiving optical subassembly to the receiver circuit and the second surface forming a first ground layer connected to the ground layer on the printed circuit board,
wherein the second flexible printer circuit is arranged such that the second surface faces the surface of the printed circuit board on which the transmitter circuit is installed.

2. The optical transceiver according to claim 1,
wherein the second flexible circuit is connected with the surface of the printed circuit board on which the transmitter circuit is installed.

3. The optical transceiver according to claim 1,
wherein the second flexible circuit is connected with a surface of the printed circuit board opposite to the surface on which the transmitter circuit is installed.

4. The optical transceiver according to claim 1,
wherein the receiver circuit is installed on a surface of the printed circuit board opposite to the surface on which the transmitter circuit is installed.

5. The optical transceiver according to claim 1, further comprising:
a shield member,
wherein the receiver circuit is installed on the surface of the printed circuit board on which the transmitter circuit is installed, and
wherein the shield member is installed on the printed circuit board so as to cover the receiver circuit.

6. The optical transceiver according to claim 5,
wherein the shield member includes a third flexible printed circuit including a second ground layer, a first edge forming an electrode connected to the second ground layer, and a second edge opposite to the first edge, the electrode being connected to the ground layer on the printed circuit board, the third flexible printed circuit being arched with the second edge as a fixed point.

7. The optical transceiver according to claim 6,
wherein the second ground layer is arranged inside of the arched shape of the third flexible printed circuit.

8. The optical transceiver according to claim 6,
wherein the second ground layer is removed in the second edge of the third flexible printed circuit.
